(19) United States
(12) Patent Application Publication
(10) Pub. No.: US 2017/0102537 A1
(43) Pub. Date: Apr. 13, 2017

(54) OPTICAL SCANNING ACTUATOR AND OPTICAL SCANNING APPARATUS

(71) Applicant: OLYMPUS CORPORATION, Tokyo (JP)

(72) Inventors: Masato FUJIWARA, Tokyo (JP); Takeharu INNAMI, Tokyo (JP)

(73) Assignee: OLYMPUS CORPORATION, Tokyo (JP)

(21) Appl. No.: 15/385,154

(22) Filed: Dec. 20, 2016

Related U.S. Application Data
(63) Continuation of application No. PCT/JP2015/003118, filed on Jun. 22, 2015.

(30) Foreign Application Priority Data
Jun. 25, 2014 (JP) 2014-130350

(51) Int. Cl. G02B 26/10; G02B 23/24

(52) U.S. Cl. CPC G02B 26/103; G02B 23/2469

(57) ABSTRACT

An optical scanning actuator (1) includes an optical fiber (2) having a tip (2a) supported to allow vibration and includes a piezoelectric element (4) that generates a driving force by expanding and contracting in the direction of the optical axis of the optical fiber (2), the driving force driving the tip (2a) of the optical fiber (2) in a direction perpendicular to the optical axis. The optical scanning actuator (1) has rotational asymmetry or two-fold rotational symmetry about the optical axis of the optical fiber (2), and the resonance direction of the tip (2a) of the optical fiber (2) and the direction of the driving force of the piezoelectric element (4) are substantially parallel.

### CROSS-REFERENCE TO RELATED APPLICATION

The present application is a Continuing Application based on International Application PCT/JP2015/003118 filed on Jun. 22, 2015, which, in turn, claims the priority from Japanese Patent Application No. 2014-130350 filed on Jun. 25, 2014, the entire disclosure of these earlier applications being herein incorporated by reference.

### TECHNICAL FIELD

This disclosure relates to an optical scanning actuator and an optical scanning apparatus.

### BACKGROUND

In recent years, in the field of endoscopes and the like, optical scanning actuators for optically scanning an object by vibrating the tip of an optical fiber near the resonance frequency have been proposed (for example, see WO 2013/069382 (PTL 1) and JP 2009-212519 A (PTL 2)). In these apparatuses, piezoelectric elements that directly or indirectly exert a force on the optical fiber are disposed in the optical axis direction of the optical fiber, and the optical fiber is driven by vibration by applying AC voltage to the piezoelectric elements.

FIGS. 16A and 16B illustrate a schematic example of an ideal optical scanning actuator. FIG. 16A is a side view, and FIG. 16B is a cross-sectional view from the optical axis direction. An optical scanning actuator 101 includes an optical fiber 102; a cuboid ferrule 103, one end of which is fixed to a device holder 107, the central portion of the optical fiber 102 being inserted through the ferrule 103 in the longitudinal direction; and piezoelectric elements 104a to 104d disposed on the four sides of the ferrule 103. The piezoelectric elements 104a to 104d respectively include piezoelectric material 105a to 105d and electrodes 106a to 106d, with the piezoelectric material 105a to 105d being disposed between the ferrule 103 and the electrodes 106a to 106d. The electrodes 106a to 106d are further connected to a non-illustrated driving circuit by wires 108a to 108d.

By applying AC voltage to the electrodes 106a and 106c, the optical scanning actuator 101 can scan the tip 102a of the optical fiber 102 in the y direction, which is orthogonal to the z direction, i.e. the optical axis direction.

FIGS. 17A and 17B illustrate operation of the optical scanning actuator in FIGS. 16A and 16B. FIG. 17A is a side view, and FIG. 17B is a cross-sectional view from the optical axis direction. When the ferrule is at ground voltage, the piezoelectric material 105a, 105c expands and contracts in the optical axis direction of the optical fiber 102 by positive or negative voltage being applied to the electrodes 106a, 106c. Accordingly, by applying AC voltage to the piezoelectric elements 104a, 104c so that one of the piezoelectric elements expands while the other contracts in the optical axis direction, the tip 102a of the optical fiber can be caused to vibrate in the y direction.

Similarly, the tip 102a can also be caused to vibrate in the x direction by applying AC voltage to the piezoelectric elements 104b, 104d.

### CITATION LIST

### Patent Literature

PTL 1: WO 2013/069382

PTL 2: JP 2009-212519 A

### SUMMARY

An optical scanning actuator according to this disclosure comprises:

an optical fiber that has a tip supported to allow vibration; and

at least one piezoelectric element configured to generate a driving force by expanding and contracting in a direction of an optical axis of the optical fiber, the driving force driving the tip of the optical fiber in a direction perpendicular to the optical axis;

wherein the optical scanning actuator has rotational asymmetry or two-fold rotational symmetry about the optical axis of the optical fiber; and

wherein a resonance direction of the tip of the optical fiber and a direction of the driving force of the at least one piezoelectric element are substantially parallel.

The optical scanning actuator may be configured to have rotational asymmetry about the optical axis of the optical fiber.

The at least one piezoelectric element may comprise a first piezoelectric element, a second piezoelectric element, and a third piezoelectric element, the second piezoelectric element and the third piezoelectric element being disposed opposite the first piezoelectric element with the optical fiber therebetween.

The optical scanning actuator preferably further comprises a ferrule configured to hold the optical fiber, and the at least one piezoelectric element is preferably fixed to a side of the ferrule.

An optical scanning apparatus according to this disclosure comprises:

any one of the above-described optical scanning actuators;

an optical input interface configured to cause illumination light from a light source to be incident on an opposite end of the optical fiber from the tip;

an optical system configured to irradiate an object with light emitted from the tip of the optical fiber; and

a controller configured to perform a scan by controlling voltage applied to the at least one piezoelectric element so that the tip of the optical fiber traces a desired scanning trajectory.

There is a particular direction, i.e. the resonance direction, in which an optical scanning actuator easily resonates when the tip of the optical fiber is vibrated, due to the shape and arrangement of the members in the optical scanning actuator. This disclosure is based on the finding that a linear, stable scanning trajectory can be obtained by causing this resonance direction and the direction of the driving force that drives the optical fiber to match. There are two resonance directions that are orthogonal to each other, and when the optical scanning actuator performs a scan in two dimensions, distortion and inclination of the scanning trajectory can be suppressed by causing the direction of the driving force to match the two resonance directions that are orthogonal to each other.

### BRIEF DESCRIPTION OF THE DRAWINGS

In the accompanying drawings:

FIG. 1 is a perspective view of an optical scanning actuator according to Embodiment 1;

FIG. 2 is a cross-sectional diagram of the optical scanning actuator in FIG. 1;

FIG. 3 illustrates the trajectory of the optical fiber tip in a simulation when using the optical scanning actuator in FIG. 2;

FIG. 4 is a cross-sectional diagram of a comparative example of an optical scanning actuator;

FIG. 5 illustrates the trajectory of the optical fiber tip in a simulation when using the optical scanning actuator in the comparative example in FIG. 4;

FIG. 6 is a cross-sectional diagram of an optical scanning actuator according to Embodiment 2;

FIG. 7 is a cross-sectional diagram of an optical scanning actuator according to Embodiment 3;

FIG. 8 is a cross-sectional diagram of an optical scanning actuator according to Embodiment 4;

FIG. 9 is a cross-sectional diagram of an optical scanning actuator according to Embodiment 5;

FIG. 10 is a perspective view (excluding the optical fiber) of an optical scanning actuator according to Embodiment 6;

FIG. 11 is a cross-sectional diagram illustrating the shape of piezoelectric material in the manufacturing process for the optical scanning actuator in FIG. 10;

FIG. 12 is a cross-sectional diagram of the optical scanning actuator in FIG. 10;

FIG. 13 is a block diagram schematically illustrating the structure of an optical scanning endoscope apparatus that is an example of an optical scanning apparatus according to Embodiment 7;

FIG. 14 is an external view schematically illustrating the scope of the optical scanning endoscope apparatus in FIG. 13;

FIG. 15 is a cross-sectional diagram of the tip of the scope in FIG. 14;

FIGS. 16A and 16B schematically illustrate the configuration of an ideal optical scanning actuator, where FIG. 16A is a side view, and FIG. 16B is a cross-sectional view from the optical axis direction; and

FIGS. 17A and 17B illustrate operation of the optical scanning actuator in FIGS. 16A and 16B, where FIG. 17A is a side view, and FIG. 17B is a cross-sectional view from the optical axis direction.

### DETAILED DESCRIPTION

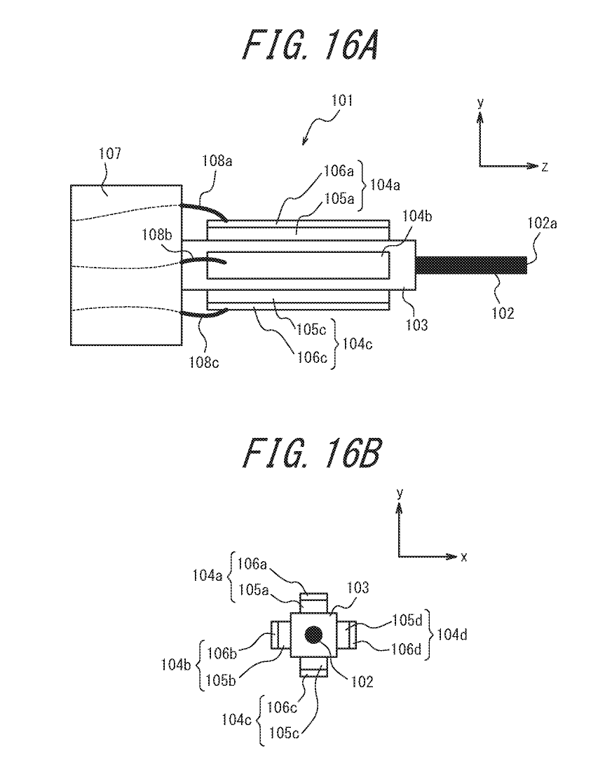

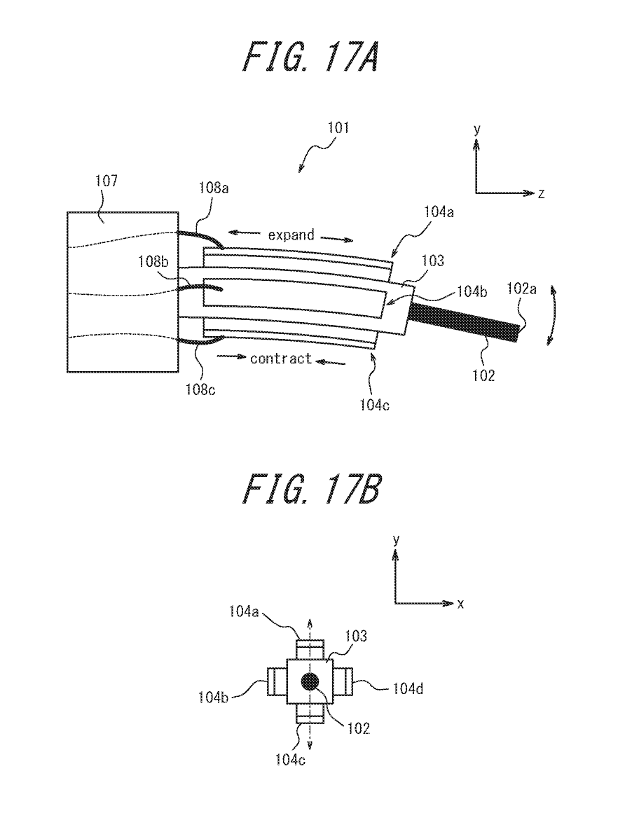

When using a single mode optical fiber for visible light in the optical fiber, however, the optical fiber diameter is approximately 100 μm, and the ferrule and piezoelectric elements for driving such an optical fiber are extremely small. In particular, in an optical scanning actuator using a ferrule such as the one illustrated in FIGS. 16A and 16B, it is difficult to increase the processing accuracy of the ferrule, and it is difficult to adhere the piezoelectric elements accurately to the center of the sides of the ferrule. For such reasons, it is difficult to achieve an ideal configuration in which the piezoelectric elements 104a to 104d are disposed evenly on the cuboid-shaped ferrule 103 so that a cross-section thereof, such as the one illustrated in FIG. 16B, is square.

In an actual optical scanning actuator, factors including error in the shape of the material that holds the optical fiber, such as the ferrule, and misalignment in the positioning of the piezoelectric elements cause problems such as the following: vibration not being sufficient despite applying vibration voltage to the optical fiber in one direction, the scanning trajectory of the optical fiber tip becoming elliptical, and/or the scanning trajectory being inclined.

Accordingly, it would be helpful to provide an optical scanning actuator that yields a scanning trajectory in which undesired distortion and inclination are suppressed near the resonance frequency, even when the processing accuracy and attachment position of members is not accurate (in the case of rotational asymmetry).

Embodiments are described below with reference to the drawings.

### Embodiment 1

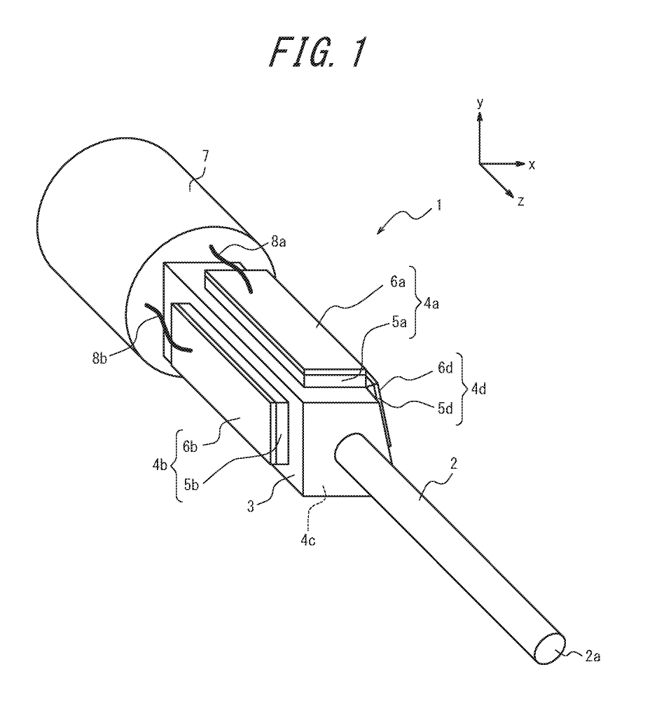

FIG. 1 is a perspective view of an optical scanning actuator according to Embodiment 1. An optical scanning actuator 1 includes an optical fiber 2; a ferrule 3 including a through-hole, through which the optical fiber 2 is inserted, in the central portion of the ferrule 3 along the longitudinal direction; piezoelectric elements 4a to 4d disposed on the four sides of the ferrule 3; a device holder 7 that holds one end of the ferrule 3; and wires 8a to 8d (8c and 8d not being illustrated) that apply voltage to the piezoelectric elements 4a to 4d. In the drawings described below, the optical axis direction of the optical fiber is the z direction, and the directions that are orthogonal to the z direction and orthogonal to each other are the x direction and the y direction. The direction of the arrows in each drawing is the + (positive) direction, and the direction opposite the arrows is the − (negative) direction.

The optical fiber 2 is a single-mode optical fiber that leads light from a non-illustrated light source to a tip 2a. In the case of visible light, the core diameter of the optical fiber 2 is approximately 10 μm, and the cladding diameter is approximately 100 μm, for example 125 μm. The optical fiber 2 is inserted into the ferrule 3, and the tip 2a is supported by the ferrule 3 in a cantilever state allowing vibration.

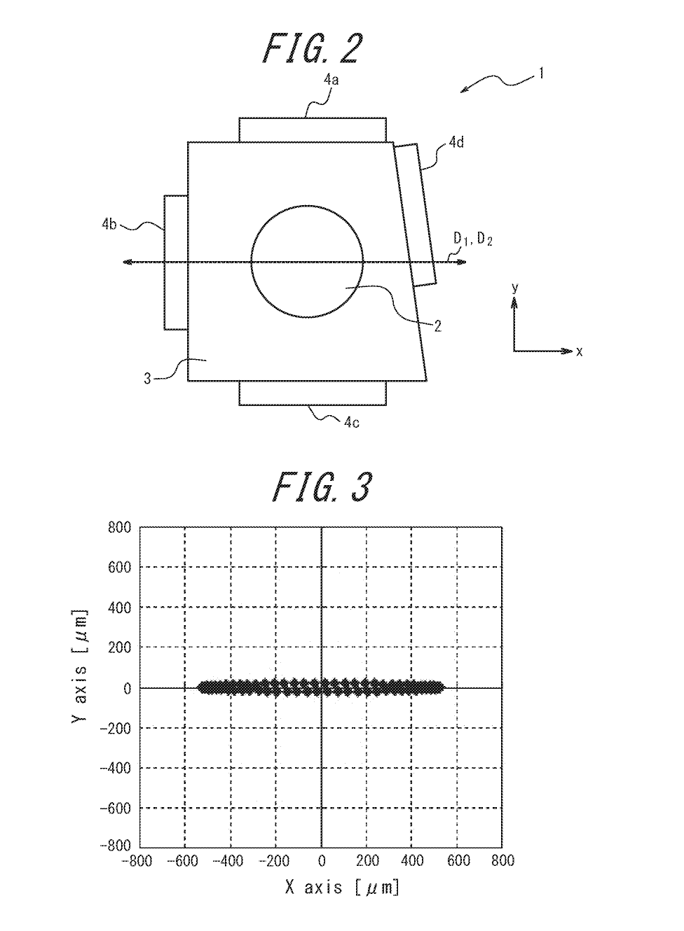

The ferrule 3 is formed from metal or another conductive material, such as Ni or kovar. FIG. 2 is a cross-sectional diagram of the optical scanning actuator 1 in FIG. 1 along a plane perpendicular to the optical axis thereof. The approximate width of the ferrule 3 is, for example, about 100 μm to 500 μm. A cross-section of the ferrule 3 is ideally a square cuboid, but in this embodiment, due to limits on accuracy at the time of manufacturing, the side on which the piezoelectric element 4d is disposed is inclined, so that the cross-section has a trapezoidal shape. Accordingly, the ferrule 3 has a rotationally asymmetric shape about the optical axis of the optical fiber 2.

The piezoelectric elements 4a to 4d are disposed on the four sides of the ferrule 3. As illustrated in FIG. 1, the piezoelectric elements 4a to 4d are respectively configured to include piezoelectric material 5a to 5d fixed to the side of the ferrule 3 and electrodes 6a to 6d adhered to the opposite side of the piezoelectric material 5a to 5d from the ferrule 3. From FIG. 2 onward, the piezoelectric elements are only illustrated as 4a to 4d, with the structure of the piezoelectric material 5a to 5d and the electrodes 6a to 6d being omitted as appropriate. The piezoelectric element material 5a to 5d has the characteristic of extending or contracting in the optical axis direction upon application of voltage between the corresponding electrodes 6a to 6d and the ferrule 3. Upon applying voltage to opposing piezoelectric elements to cause one of the piezoelectric elements to expand and the other to contract, the optical fiber 2 flexes in the direction of the piezoelectric element that contracts. Therefore, the tip 2a of the optical fiber 2 is driven in a direction perpendicular to the optical axis. When a cross-section of the ferrule 3 is an ideal square shape, the piezoelectric elements 4a and 4c oppose each other in the y direction, and the piezoelectric elements 4b and 4d oppose each other in the x direction.

The wires 8a to 8d are connected to the electrodes 6a to 6d by a method such as soldering, are passed through the inside of the device holder 7, and are connected to a non-illustrated driving circuit. Taking the voltage of the ferrule 3 as the ground voltage, the driving circuit applies voltage to the opposing electrodes 6a to 6d so as to obtain the desired scanning trajectory. At this time, the opposing electrode 6a and electrode 6c form a pair and are controlled so that when one expands, the other contracts. In this way, the tip 2a of the optical fiber 2 can be displaced approximately in the y direction. Similarly, by controlling the opposing electrodes 6b and 6d in the same way, the tip 2a of the optical fiber 2 can be displaced approximately in the x direction.

If the piezoelectric elements 4a and 4c and the piezoelectric elements 4b and 4d drive the tip 2a of the optical fiber 2 in directions orthogonal to each other, then the AC voltage that is applied to the electrodes 6a, 6c and the electrodes 6b, 6d has the same frequency, a 90° shift in phase, and an amplitude that gradually changes between 0 and the maximum value. As a result, a so-called spiral scan can be performed on an object with emission light from the optical fiber 2. By applying AC voltage with different frequencies and a constant amplitude between the electrodes 6a, 6c and the electrodes 6b, 6d, a so-called Lissajous scan or raster scan can be performed.

In this embodiment, however, the ferrule 3 has a rotationally asymmetric trapezoidal shape. Therefore, upon disposing the piezoelectric element 4d in the y direction center of the inclined side on which the piezoelectric element 4d is disposed (the side in the +x direction in FIG. 2), the driving force from the piezoelectric element 4d is inclined from the x direction, and the resonance direction of the scanning device also becomes inclined. As a result, focusing on the x-axis, problems occur when the driving frequency is brought near the resonance frequency, such as the trajectory becoming an ellipse, or the amplitude decreasing.

Therefore, in this embodiment, as illustrated in FIG. 2, the piezoelectric element 4d is disposed on the side of the ferrule 3 with a narrower width in the x direction (the +y side), so that the resonance direction (D₁) of the tip 2a of the optical fiber 2 and the driving force direction (D₂) of the piezoelectric elements 4b, 4d nearly match. As a result, a straight trajectory with no inclination or distortion can be obtained even when the optical scanning actuator 1 is driven in the x direction and the driving frequency is near the resonance frequency.

FIG. 3 illustrates the trajectory of the tip 2a of the optical fiber 2 in a simulation when using the optical scanning actuator 1 in FIG. 2. By applying AC voltage with a frequency near the resonance frequency to the piezoelectric elements 4b, 4d to drive the optical scanning actuator 1 in the y direction, the tip 2a of the optical fiber 2 traverses a trajectory that vibrates straight in the y direction.

Thus, in this embodiment, the resonance direction of the tip 2a of the optical fiber 2 and the direction of the driving force generated by the piezoelectric elements 4b and 4d are substantially parallel. Therefore, a scanning trajectory in which undesired distortion and inclination are suppressed near the resonance frequency can be obtained even when the processing accuracy and attachment position of members in the optical scanning actuator 1 such as the ferrule 3 and/or the piezoelectric elements 4a to 4d are not accurate (in the case of rotational asymmetry).

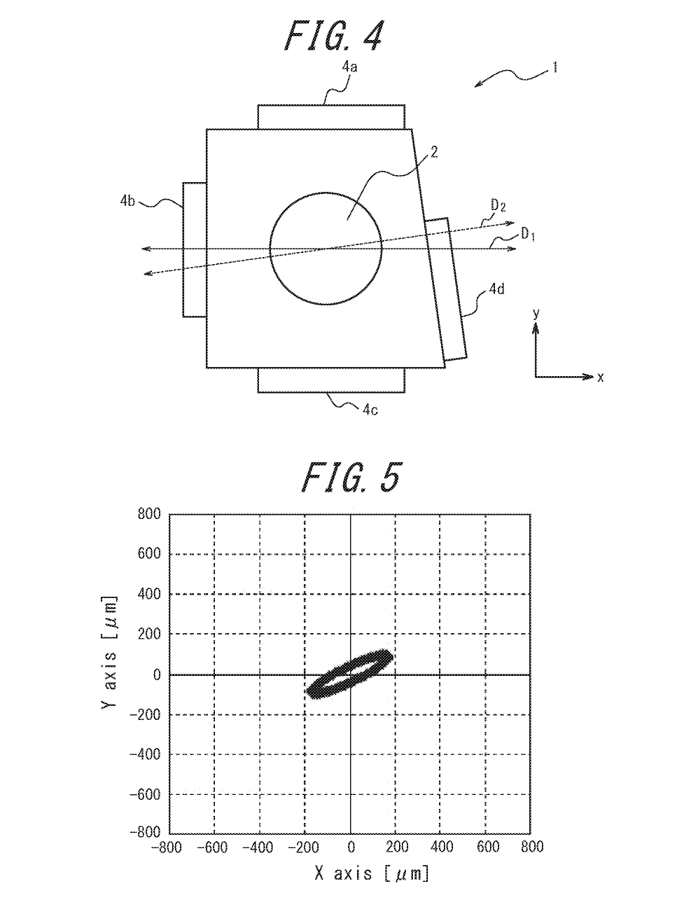

On the other hand, FIG. 4 is a cross-sectional diagram of an optical scanning actuator 1 according to a comparative example, and FIG. 5 illustrates the trajectory of the tip 2a of the optical fiber 2 in a simulation when using the optical scanning actuator 1 according to the comparative example in FIG. 4. In this comparative example, the piezoelectric element 4d is disposed on the side where the width of the ferrule 3 is wider in the x direction (the −y side). By disposing the piezoelectric element 4d in this way, a large misalignment occurs between the resonance direction (D₁) of the tip 2a of the optical fiber 2 and the driving force direction (D₂) of the piezoelectric elements 4b, 4d. Accordingly, by applying AC voltage on the piezoelectric elements 4b, 4d and driving the optical scanning actuator 1 in the y direction, the trajectory of the tip 2a of the optical fiber 2 is an inclined elliptical trajectory.

In the optical scanning actuator 1 of this embodiment, unlike the aforementioned comparative example, the optical fiber tip 2 traverses a linear trajectory in the driving force direction of the piezoelectric elements 4b, 4d even near the resonance frequency. Therefore, according to this embodiment, a scanning trajectory in which undesired distortion and inclination are suppressed near the resonance frequency can be obtained even when the processing accuracy of the ferrule 3 is low (in the case of rotational asymmetry). Furthermore, since distortion and inclination are suppressed near the resonance frequency, the fiber can be driven efficiently with a large amplitude near the resonance frequency.

### Embodiment 2

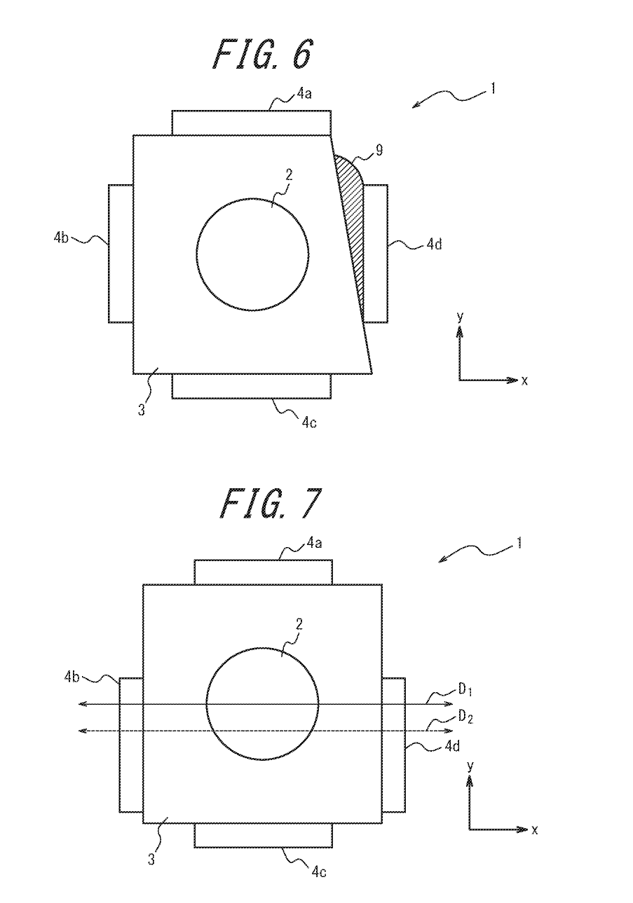

FIG. 6 is a cross-sectional diagram of the optical scanning actuator 1 according to Embodiment 2 along a plane perpendicular to the optical axis thereof. As in Embodiment 1, the processing accuracy of the ferrule 3 is insufficient in this embodiment. Therefore, the cross-sectional shape of the ferrule 3 is a trapezoid with respect to the optical axis of the optical fiber 2. To address this problem, a gap is filled using adhesive 9 on the inclined side of the ferrule 3 on which the piezoelectric element 4d is disposed (the side in the +x direction in FIG. 6), and the piezoelectric element 4d is attached so as to be parallel to the piezoelectric element 4b. As a result, the resonance direction of the optical scanning actuator 1 and the direction of the driving force of the piezoelectric elements 4a to 4d match in the x direction. The material filling the gap is not limited to adhesive, and the density of the material is preferably near the density of the ferrule 3. Since the remaining structure is similar to Embodiment 1, identical or corresponding constituent elements are labeled with the same reference signs, and a description thereof is omitted.

According to this embodiment, even if the processing accuracy of the ferrule 3 is insufficient, the gap is filled using adhesive 9, the piezoelectric elements 4b, 4d are disposed in parallel, and the resonance direction of the optical scanning actuator 1 matches the driving force direction of the piezoelectric elements 4b, 4d. Therefore, as with Embodiment 1, a scanning trajectory in which undesired distortion and inclination are suppressed near the resonance frequency can be obtained.

### Embodiment 3

FIG. 7 is a cross-sectional diagram of an optical scanning actuator 1 according to Embodiment 3. This embodiment illustrates the case of the attachment position being unintentionally misaligned at the stage at which the piezoelectric element 4b is attached to the ferrule 3. In this case, it is assumed that the piezoelectric element 4d that is attached after the piezoelectric element 4b can be positioned more accurately than the piezoelectric element 4b. According to the actuator in FIG. 7, the cross-sectional shape of the ferrule 3 is substantially square. Focusing on the piezoelectric elements 4b, 4d in the x-axis direction, however, the piezoelectric element 4b on the −x side is shifted in the −y direction. Therefore, by similarly shifting the piezoelectric element 4d on the +x side in the −y direction, the resonance direction (D₁) of the optical scanning actuator 1 and the driving force direction (D₂) of the piezoelectric elements 4b, 4d can be nearly matched in the x direction. As a result, a scanning trajectory in which undesired distortion and inclination are suppressed near the resonance frequency can be obtained, and the fiber can be vibrated efficiently. In this case as well, the optical scanning actuator 1 is rotationally asymmetric. Since the remaining structure is similar to Embodiment 1, identical or corresponding constituent elements are labeled with the same reference signs, and a description thereof is omitted.

When the piezoelectric elements 4a to 4d are adhered to the ferrule 3, if one piezoelectric element 4b is adhered freely without using precise positioning means, and the position of attachment is displaced from the center, then the optical scanning actuator 1 according to this embodiment can be achieved by precisely adjusting and attaching the opposing piezoelectric element 4d with a jig or the like. In this way, the number of steps for precise adjustment can be cut in half, leading to a reduction in manufacturing costs.

### Embodiment 4

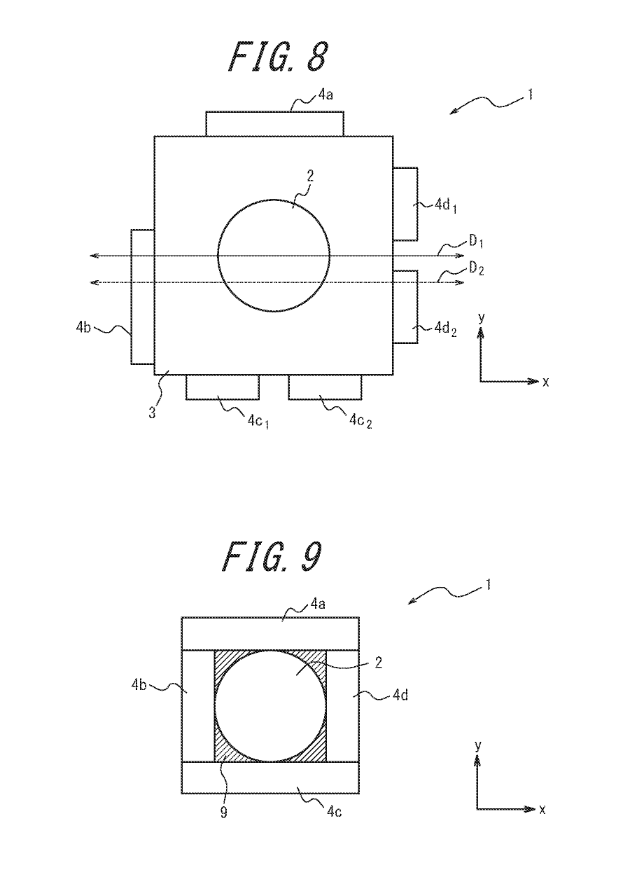

FIG. 8 is a cross-sectional diagram of an optical scanning actuator 1 according to Embodiment 4. In this optical scanning actuator 1, the piezoelectric elements 4a and 4c that oppose each other in the y direction are such that the piezoelectric element 4a (first piezoelectric element) is configured by one piezoelectric element, whereas the other piezoelectric element 4c is configured by two piezoelectric elements 4c₁, 4c₂ that are long in the z direction and are aligned in the x direction (second piezoelectric element, third piezoelectric element). Similarly, the piezoelectric elements 4b and 4d that oppose each other in the x direction are such that the piezoelectric element 4b is configured by one piezoelectric element, whereas the other piezoelectric element 4d is configured by two piezoelectric elements 4d₁, 4d₂ that are long in the z direction and are aligned in the y direction. As a result, the optical scanning actuator 1 is rotationally asymmetric. A cross-section of the ferrule 3 is preferably a square cuboid, the piezoelectric element 4a is preferably positioned in the center of the face of the ferrule 3 in the y direction, and the piezoelectric element 4b is preferably positioned in the center of the face of the ferrule 3 in the −x direction. As in the above embodiments, however, it is difficult to increase the accuracy of these shapes and positions. Since the remaining structure is similar to Embodiment 1, identical or corresponding constituent elements are labeled with the same reference signs, and a description thereof is omitted.

In the optical scanning actuator 1 according to this embodiment, in the case of the attachment position being unintentionally misaligned at the stage at which the piezoelectric element 4b in the x direction is attached to the ferrule 3, the resonance direction D₁ of the optical scanning actuator 1 and the driving force direction D₂ of the piezoelectric elements 4b, 4d₁, 4d₂ can be nearly matched by adjusting the voltage value between the two opposing piezoelectric elements 4d₁, 4d₂. Hence, the driving frequency can be brought near the resonance frequency, and the optical fiber 2 can be vibrated efficiently.

For example, as illustrated in FIG. 8, if the piezoelectric element 4b on the −x side is unintentionally shifted in the −y direction, then between the two piezoelectric elements 4d₁, 4d₂, a larger voltage is applied to the piezoelectric element 4d₂ on the −y side, and a smaller voltage is applied to the one on the +y side. By doing so, the resonance direction D₁ of the optical scanning actuator 1 and the driving force direction D₂ of the piezoelectric elements 4b, 4d₁, 4d₂ can be nearly matched. Hence, the driving frequency can be brought near the resonance frequency, and the optical fiber 2 can be vibrated efficiently.

The piezoelectric elements 4b, 4d₁, 4d₂ disposed on the sides in the x direction of the ferrule 3 have been described, but the same adjustments may also be made for the piezoelectric elements 4a, 4c₁, 4c₂ disposed on the sides in the y direction so as to make the resonance direction and the direction of the driving force of the piezoelectric elements 4a, 4c₁, 4c₂ nearly match. Even when there is distortion in the shape of the ferrule 3, adjustments can be made so that the resonance frequency and the driving force direction of the piezoelectric elements match by adjusting the voltage between the piezoelectric element 4c₁ and the 4c₂ and adjusting the voltage between the piezoelectric element 4d₁ and the piezoelectric element 4d₂.

Hence, according to this embodiment, one piezoelectric element 4a is disposed on one side of the ferrule 3 through which the optical fiber 2 is inserted, and two piezoelectric elements 4c and 4c₂ are disposed on the side opposite the piezoelectric element 4a, whereby the resonance frequency and the driving force direction of the piezoelectric elements can be caused to match by adjusting the voltage applied to the two piezoelectric elements 4c₁ and 4c₂. As a result, a scanning trajectory in the x direction in which undesired distortion and inclination are suppressed near the resonance frequency can be obtained. The same is true for scanning in the y direction as well.

### Embodiment 5

FIG. 9 is a cross-sectional diagram of an optical scanning actuator 1 according to Embodiment 5. This optical scanning actuator 1 is unlike the above embodiments in that no ferrule is used. Rather, the piezoelectric elements 4a to 4d are adhered directly to the optical fiber 2 with adhesive 9 or the like. In general, it is extremely difficult to attach the piezoelectric elements 4a to 4d, which oppose each other in the x direction and the y direction, so as to be parallel. When the piezoelectric elements 4a to 4d are inclined in the x direction or the y direction, problems occur such as the trajectory becoming an ellipse.

Therefore, in this embodiment, the length of the piezoelectric elements 4a, 4c that oppose each other in the y direction and of the piezoelectric elements 4b, 4d that oppose each other in the x direction is changed. For example, the piezoelectric elements 4b, 4d that oppose each other in the x direction are configured to have the same width as the diameter of the optical fiber 2, and the piezoelectric elements 4a and 4c that oppose each other in the y direction are configured so as to have a width equal to the diameter of the optical fiber 2 plus twice the thickness of each piezoelectric element. By adopting this configuration, in addition to the piezoelectric elements 4a to 4d contacting the optical fiber 2, the piezoelectric elements 4b, 4d are sandwiched between opposing surfaces of the piezoelectric elements 4a, 4c. The piezoelectric elements 4a to 4d are thus positioned stably at right angles to each other. Since the piezoelectric elements 4a, 4c are wider than the piezoelectric elements 4b, 4d, a larger driving force is generated by applying the same voltage. Therefore, adjustment is made to apply a relatively smaller voltage to the piezoelectric elements 4b, 4d. The optical scanning actuator 1 of this embodiment has two-fold rotational symmetry.

By adopting this configuration, the resonance direction of the optical scanning actuator 1 and the driving force direction of the piezoelectric elements 4a to 4d can be nearly matched, and a scanning trajectory in which undesired distortion and inclination are suppressed near the resonance frequency can be obtained. Furthermore, the driving frequency can be brought near the resonance frequency, and the optical fiber 2 can be vibrated efficiently. Also, an advantage over Embodiments 1 to 4 is that no ferrule is necessary.

### Embodiment 6

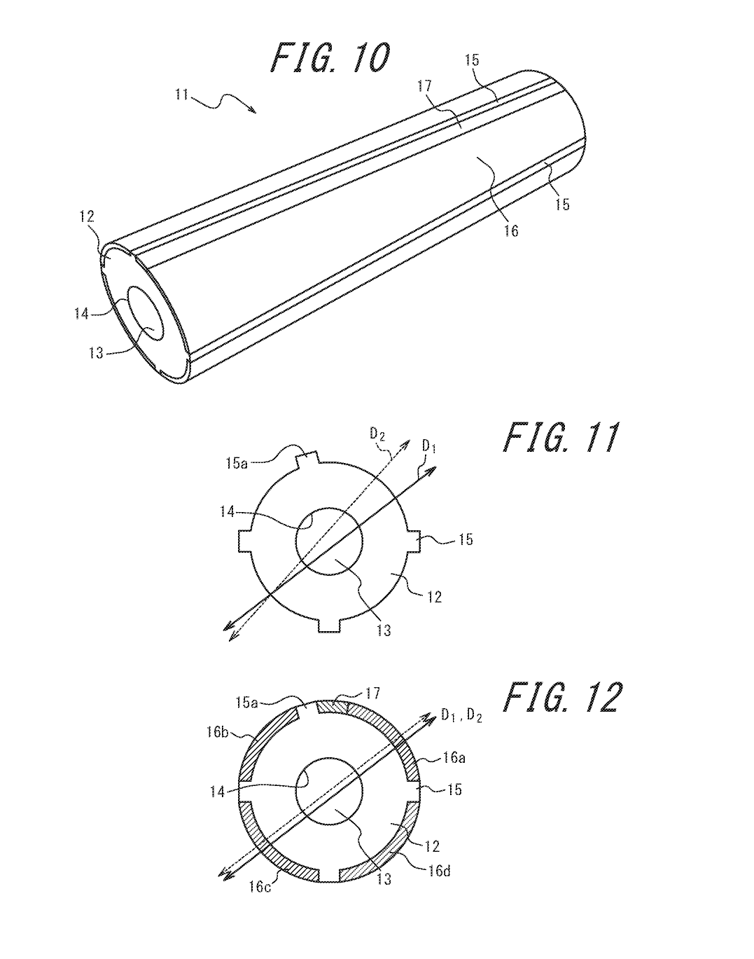

FIG. 10 is a perspective view (excluding the optical fiber) of an optical scanning actuator 11 according to Embodiment 6. FIG. 11 is a cross-sectional diagram illustrating the shape of piezoelectric material in the manufacturing process for the optical scanning actuator 11 in FIG. 10. Furthermore, FIG. 12 is a cross-sectional diagram of the optical scanning actuator 11 in FIG. 10.

This optical scanning actuator 11 is provided with roughly cylindrical piezoelectric material 12, and a central electrode 14 is provided on the outer circumferential surface (the inner circumferential surface of the cylinder) of an inner cavity 13, through which the optical fiber is inserted, that extends in the longitudinal direction along the center of the cylindrical piezoelectric material 12. Four protrusions (separation regions) 15 are provided around the piezoelectric material 12. Furthermore, around the piezoelectric material 12, four electrodes 16 are disposed along the outer circumference of the piezoelectric material 12 with the four protrusions 15 therebetween. Insulating material 17 is also sandwiched between one of the protrusions 15 and the electrode 16 adjacent thereto. Non-illustrated wires are connected to the central electrode 14 and each of the electrodes 16, and AC voltage is applied from an external source. By applying voltage between the central electrode 14 and the electrodes 16, the piezoelectric material 12 sandwiched between the electrodes 16 and the central electrode 14 expands and contracts, vibrating the tip of the inserted optical fiber.

This sort of optical scanning actuator 11 can be created by first forming protrusions 15 on the piezoelectric material 12, depositing conductive coating around the piezoelectric material 12 including the protrusions 15, then removing a portion of the deposited coating in the circumferential direction of the piezoelectric material 12 at equal distances from the optical axis so as to expose the protrusions 15, and finally forming the electrodes 16 separated by the protrusions 15.

When forming the protrusions 15, however, if the position of one of the protrusions 15a is misaligned in the circumferential direction, as illustrated in FIG. 11, then forming the electrodes 16 in this state causes the driving force direction D₂ of the opposing electrodes 16 to be misaligned relative to the resonance direction D₁ of the optical scanning actuator 11.

Therefore, in the optical scanning actuator 11 illustrated in FIGS. 10 and 12, misalignment of the protrusion 15a is supplemented by the insulating material 17, thereby causing the resonance direction D₁ of the optical scanning actuator 11 and the driving force direction D₂ acting on the piezoelectric material 12 due to the opposing electrode 16a and electrode 16c to match. As a result, a scanning trajectory in which undesired distortion and inclination are suppressed near the resonance frequency can be obtained, and the optical fiber can be vibrated efficiently. The insulating material 17 preferably has approximately the same density as the piezoelectric material 12.

### Embodiment 7

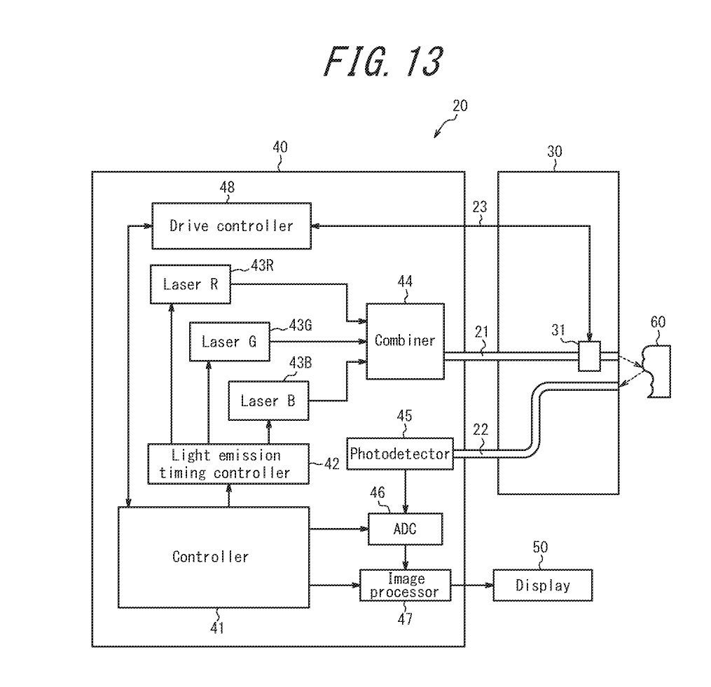

FIG. 13 is a block diagram schematically illustrating the structure of an optical scanning endoscope apparatus 20 that is an example of an optical scanning apparatus according to Embodiment 7. The optical scanning endoscope apparatus 20 includes a scope 30, a control device body 40, and a display 50.

The control device body 40 includes a controller 41 that controls the optical scanning endoscope apparatus 20 overall, a light emission timing controller 42, lasers 43R, 43G, and 43B, and a combiner 44 (optical input interface). Under the control of the controller 41, the light emission timing controller 42 controls the light emission timing of the three lasers 43R, 43G, and 43B that emit laser light of three primary colors, i.e. red, green, and blue. For example, Diode-Pumped Solid-State (DPSS) lasers or laser diodes may be used as the lasers 43R, 43G, and 43B. The laser light emitted from the lasers 43R, 43G, and 43B is combined by the combiner 44 and is incident as white illumination light on an optical fiber 21 for illumination, which is a single-mode fiber. The configuration of the light source in the optical scanning endoscope apparatus 20 is not limited to this example. A light source with one laser may be used, or a plurality of other light sources may be used. The lasers 43R, 43G, and 43B and the combiner 44 may be stored in a housing that is separate from the control device body 40 and is joined to the control device body 40 by a signal wire.

The optical fiber 21 for illumination is connected to the tip of the scope 30, and light incident on the optical fiber 21 for illumination from the combiner 44 is guided to the tip of the scope 30 and irradiated towards an object 60. By a driver 31 being subjected to vibration driving, the illumination light emitted from the optical fiber 21 for illumination can perform a 2D scan on the observation surface of the object 60. As described below, the driver 31 is configured to include an optical scanning actuator of this disclosure. The driver 31 is controlled by a drive controller 48 of the below-described control device body 40. Signal light such as reflected light, scattered light, or fluorescent light that is obtained from the object 60 due to irradiation with the illumination light is received at the tip of an optical fiber 22 for detection, which is constituted by a plurality of multi-mode fibers, and is guided through the scope 30 to the control device body 40.

The control device body 40 further includes a photodetector 45 for processing signal light, an analog/digital converter (ADC) 46, and an image processor 47. The photodetector 45 divides the signal light that passed through the optical fiber 22 for detection into spectral components and converts the spectral components into electrical signals with a photodiode or the like. The ADC 46 converts the image signal, which was converted into an electrical signal, to a digital signal and outputs the result to the image processor 47. The controller 41 calculates information on the scanning position along the scanning path from information such as the amplitude and phase of vibration voltage applied by the drive controller 48 and provides the result to the image processor 47. The image processor 47 obtains pixel data on the object 60 at the scanning position from the digital signal output by the ADC 46. The image processor 47 sequentially stores information on the scanning position and the pixel data in a non-illustrated memory, generates an image of the object 60 by performing image processing, such as interpolation, as necessary after completion of the scan or during the scan, and displays the image on the display 50.

In the above-described processing, the controller 41 synchronously controls the light emission timing controller 42, the photodetector 45, the drive controller 48, and the image processor 47.

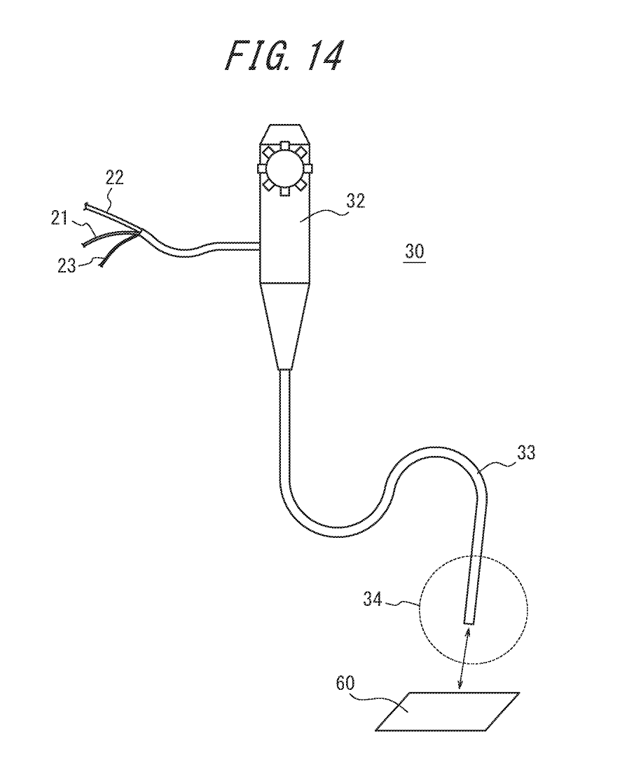

FIG. 14 is a schematic overview of the scope 30. The scope 30 includes an operation part 32 and an insertion part 33. The optical fiber 21 for illumination, the optical fiber 22 for detection, and wiring cables 23 extending from the control device body 40 are each connected to the operation part 32. The optical fiber 21 for illumination, optical fiber 22 for detection, and wiring cable 23 pass through the insertion part 33 and are drawn to a tip 34 (the portion within the dotted line in FIG. 14) of the insertion part 33.

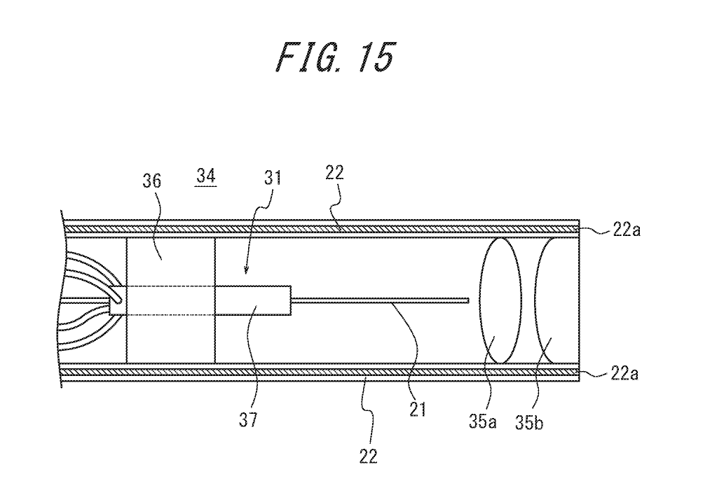

FIG. 15 is a cross-sectional diagram illustrating an enlargement of the tip 34 of the insertion part 33 of the scope 30 in FIG. 14. The tip 34 includes the driver 31, projection lenses 35a and 35b (optical system), the optical fiber 21 for illumination that passes through the central portion, and the optical fiber bundle 22 for detection that passes through the peripheral portion.

The driver 31 includes an actuator tube 37 fixed to the inside of the insertion part 33 of the scope 30 by an attachment ring 36 (corresponding to the device holder 7 in FIG. 1) and any one of the optical scanning actuators 1, 11 according to Embodiments 1 to 6 inside the actuator tube 37. The tip of the optical fiber 21 for illumination of the optical scanning actuator 1 or 11 is supported to allow vibration and irradiates illumination light via the projection lenses 35a and 35b so as to roughly concentrate the illumination light on the object 60. The optical fiber 22 for detection is disposed to pass through the peripheral portion of the insertion part 33 and extends to the end of the tip 34. A non-illustrated detection lens is also provided at the tip of each fiber in the optical fiber 22 for detection.

The optical scanning actuator 1 or 11 according to this disclosure is used as described above, and therefore the optical scanning endoscope apparatus 20 of this embodiment allows the object 60 to be scanned with a scanning trajectory in which undesired distortion and inclination are suppressed near the resonance frequency in accordance with the DC voltage that the drive controller 48 applies to the driver 31 (the optical scanning actuator). Therefore, a discrepancy between the information that the controller 41 has on the scanning position and the actual position irradiated by illumination light on the object 60 can be suppressed, thereby allowing the image processor 47 to generate an image of the object 60 in which distortion and inclination are suppressed. Furthermore, driving near the resonance frequency of the optical scanning actuator 1, 11 is possible, thus allowing more efficient scanning.

This disclosure is not limited to the above embodiments, and a variety of changes and modifications may be made. For example, all of the dimensions indicated in the above embodiments are only examples, and this disclosure is not limited to these dimensions. In Embodiments 1 to 4, the ferrule is shaped as a square prism, but the ferrule is not limited to this shape. For example, the ferrule may have a cylindrical shape, with flat surfaces being formed by cutting out portions where the piezoelectric elements are disposed. Similarly, the piezoelectric element material in Embodiment 6 is not limited to a cylindrical shape and may have any other shape, such as a square prism. In the above embodiments, the optical fiber of the optical scanning actuator is a single-mode optical fiber, but the optical fiber is not limited in this way and may be a multi-mode optical fiber.

The optical scanning apparatus of this disclosure is not limited to an optical scanning endoscope apparatus and may also be adopted in an optical scanning microscope or an optical scanning projector.

### REFERENCE SIGNS LIST

1 Optical scanning actuator
2 Optical fiber
2a Tip
3 Ferrule
4a to 4d, 4c₁, 4c₂, 4d₁, 4d₂ Piezoelectric element
5a to 5d Piezoelectric material
6a to 6d Electrode
7 Device holder
8a, 8b Wire
9 Adhesive
11 Optical scanning actuator
12 Piezoelectric material
13 Inner cavity
14 Central electrode
15 Protrusion (separation region)
16 Electrode
17 Insulating material
20 Optical scanning endoscope apparatus
21 Optical fiber for illumination
22 Optical fiber for detection
23 Wiring cable
30 Scope
31 Driver
32 Operation part
33 Insertion part
34 Tip
35a, 35b Projection lens (optical system)
36 Attachment ring
37 Actuator tube
40 Control device body
41 Controller
42 Light emission timing controller
43R, 43G, 43B Laser
44 Combiner
45 Photodetector
46 ADC
47 Image processor
48 Drive controller
50 Display
60 Object
101 Optical scanning actuator
102 Optical fiber
1033 Ferrule
104a to 104d Piezoelectric element
107 Device holder
108a, 108b Wire

1. An optical scanning actuator comprising:
an optical fiber that has a tip supported to allow vibration; and
at least one piezoelectric element configured to generate a driving force by expanding and contracting in a direction of an optical axis of the optical fiber, the driving force driving the tip of the optical fiber in a direction perpendicular to the optical axis;
wherein the optical scanning actuator has rotational asymmetry or two-fold rotational symmetry about the optical axis of the optical fiber; and
wherein a resonance direction of the tip of the optical fiber and a direction of the driving force of the at least one piezoelectric element are substantially parallel.

2. The optical scanning actuator of claim 1, the optical scanning actuator having rotational asymmetry about the optical axis of the optical fiber.

3. The optical scanning actuator of claim 1, wherein the at least one piezoelectric element comprises a first piezoelectric element, a second piezoelectric element, and a third piezoelectric element, the second piezoelectric element and the third piezoelectric element being disposed opposite the first piezoelectric element with the optical fiber therebetween.

4. The optical scanning actuator of claim 1, further comprising a ferrule configured to hold the optical fiber;
wherein the at least one piezoelectric element is fixed to a side of the ferrule.

5. An optical scanning apparatus comprising:
the optical scanning actuator of claim 1;
an optical input interface configured to cause illumination light from a light source to be incident on an opposite end of the optical fiber from the tip;
an optical system configured to irradiate an object with light emitted from the tip of the optical fiber; and
a controller configured to perform a scan by controlling voltage applied to the at least one piezoelectric element so that the tip of the optical fiber traces a desired scanning trajectory.
